(19) United States
(12) Patent Application Publication
(10) Pub. No.: US 2003/0000940 A1
(43) Pub. Date: Jan. 2, 2003

(54) Heat dissipation devices for heater elements

(76) Inventors: Sidney Furlong, Ogden, UT (US); Edward J. Zelazny, N. Ogden, UT (US); Joey A. Anderson, Taylorsville, UT (US)

Correspondence Address: Thomas V. Miller, Howrey Simon Arnold & White, LLP, PO Box 4433, Houston, TX, 77210-4433, US

(21) Appl. No.: 09/962,824

(22) Filed: Sep. 25, 2001

Related U.S. Application Data
(60) Provisional application No. 60/302,472, filed on Jul. 2, 2001.

(51) Int. Cl. H05B 3/00

(52) U.S. Cl. 219/540; 219/541

(57) ABSTRACT

A heat dissipation device for a heater. The heater having a heater element portion, cold pin portions, and connectors. The cold pin portions are connected between the heater element portion and the connectors. The heat dissipation device is connected to the cold pin portions of the heater element to dissipate conducted heat from the heater element portion. This is done through convection to the surrounding air before the conducted heat reaches the connectors.

The present application claims priority from Provisional Application Serial No. 60/302,472 entitled “Heat Dissipation Devices for Heater Elements” filed Jul. 2, 2001, commonly owned by the assignee of the present invention and incorporated herein by reference in its entirety.

### FIELD OF THE INVENTION

The present invention relates generally to heaters, and more particularly, to devices that dissipate heat that conducts from the heat generating element to its associated electrical connectors.

### BACKGROUND OF THE INVENTION

The use of heaters is a common industrial practice that has many applications. Such heaters may be required to heat an environment to maintain a desired temperature. FIGS. 1A and 1B show a conventional heater 10 that may be used to heat an environment. The heater 10 has a heater element portion 12, cold pin portions 14, and connectors 16. When power is provided to the heater 10, the heater element portion 12 is the portion of the heater 10 that generates heat. The cold pin portions 14 extend between the heater element portion 12 and the connectors 16 but do not actively generate heat when power is applied to the heater 10. Each connector 16 has a base 18 and an electrical terminal 20. The base 18 of the connectors 16 are used for mechanically attaching the heater to a wiring enclosure or other housing 22. The terminals 20 of the connectors 16 are used for electrically connecting the heater to a power source and controller.

A problem with conventional heaters is that heat generated from the heater element portion 12 will conduct through the cold pin portions 14 and to the connectors 16. This may cause failure to sensitive wiring or controller components due to excessive temperatures. To overcome this problem, it has been known to use high temperature resistant wiring and components. Such wiring and components, however, are generally more expensive. It has also been known to locate the controller a sufficient distance away from the heater 10. This also has its inefficiencies. For example, the wiring that connects the heater to the controller may still be subject to excessive temperatures. Additionally, such a connection will result in less compact assemblies. It has further been known to use a secondary-cooling source such as fans or refrigeration. These methods are typically more expensive and require additional labor to manufacture or install.

The present invention is directed to overcoming, or at least reducing the effects of, one or more of the problems set forth above.

### SUMMARY OF THE INVENTION

To that end, the present invention includes a heat dissipation device for a heater. The heater having a heater element portion, cold pin portions and connectors. The heat dissipation device includes a body portion that is attached to the at least one of the cold pin portions to dissipate heat conducted to the cold pin portion from the heater element portion. In one embodiment, the body portion of the heat dissipation device is in the shape of a strip that extends between the cold pin portions. In another embodiment, the body portion of the heat dissipation device is in the shape of a disc. In a further embodiment, the heat dissipation device has a plurality of fins. The plurality of fins extends from the body portion.

In another embodiment, the present invention includes a heater having a heater element portion, a first and second cold pin portion, a first and second connector, and at least one heat dissipation device. The heater element portion has a first and second end. The first cold pin portion is connected to the first end of the heater element portion. The second cold pin portion is connected to the second end of the heater element portion. The first connector is attached to the first cold pin portion and the second connector is attached to the second cold pin portion. The at least one heat dissipation device is attached to the first cold pin portion and the second cold pin portion.

In a further embodiment, the present invention includes a heater having a heater element portion, a first and second cold pin portion, a first and second connector, and a first and second heat dissipation device. The heater element portion has a first and second end. The first cold pin portion is connected to the first end of the heater element portion. The second cold pin portion is connected to the second end of the heater element portion. The first connector is attached to the first cold pin portion and the second connector is attached to the second cold pin portion. The first dissipation device is attached to the first cold pin portion and the second dissipation device is connected to the second cold pin portion.

The above summary of the present invention is not intended to represent each embodiment, or every aspect of the present invention. This is the purpose of the figures and detailed description that follows.

### BRIEF DESCRIPTION OF THE DRAWINGS

Other objects and advantages of the invention will become apparent upon reading the following detailed description and upon reference to the drawings.

The foregoing and other aspects of the present invention will be best understood with reference to a detailed description of specific embodiments of the invention, which follows, when read in conjunction with the accompanying drawings, in which:

FIGS. 1A-1B are side views of a conventional, prior art heater that may be used to heat an environment.

FIG. 2 is perspective view of one embodiment of a heater having a heat dissipation device according to the present invention.

FIG. 3 is a side view of the heater in FIG. 2.

FIGS. 4A-B are side and plan views of a strip of the heat dissipation device in FIG. 3.

FIG. 5 is a side view of another embodiment of a heater having a heat dissipation device according to the present invention.

FIGS. 6A-B are side and plan views of the heat dissipation device for the heater in FIG. 5.

FIG. 7 is a side view of another embodiment of a heater having a heat dissipation device according to the present invention.

FIGS. 8A-B are side and plan views of the heat dissipation device for the heater in FIG. 7.

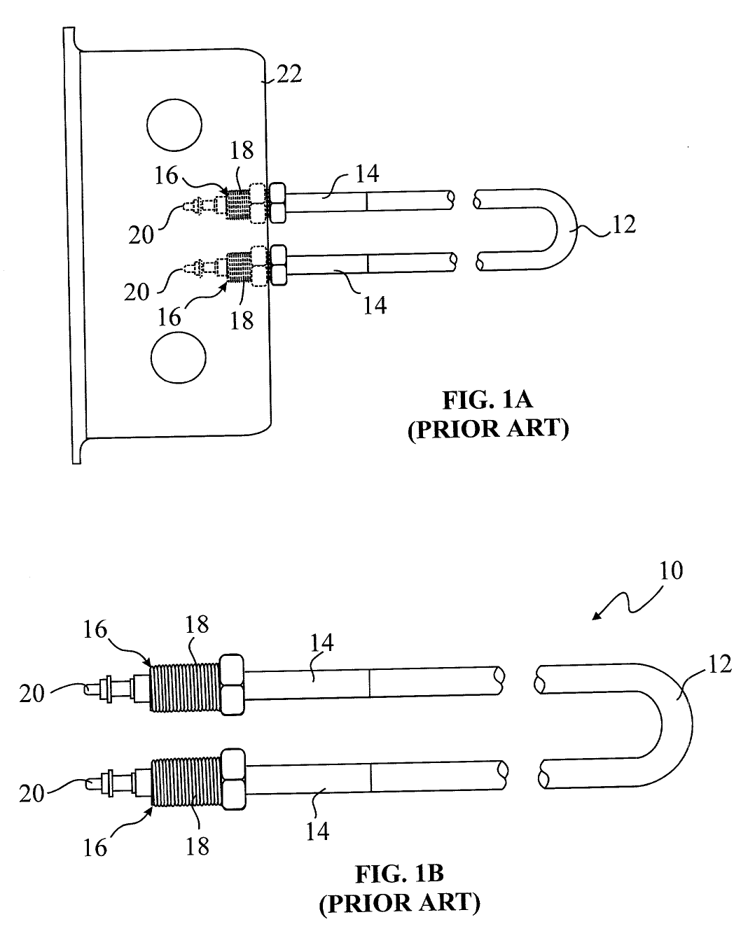

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modification, equivalents and alternatives falling within the scope of the invention as defined by the appended claims.

### DESCRIPTION OF ILLUSTRATIVE EMBODIMENTS

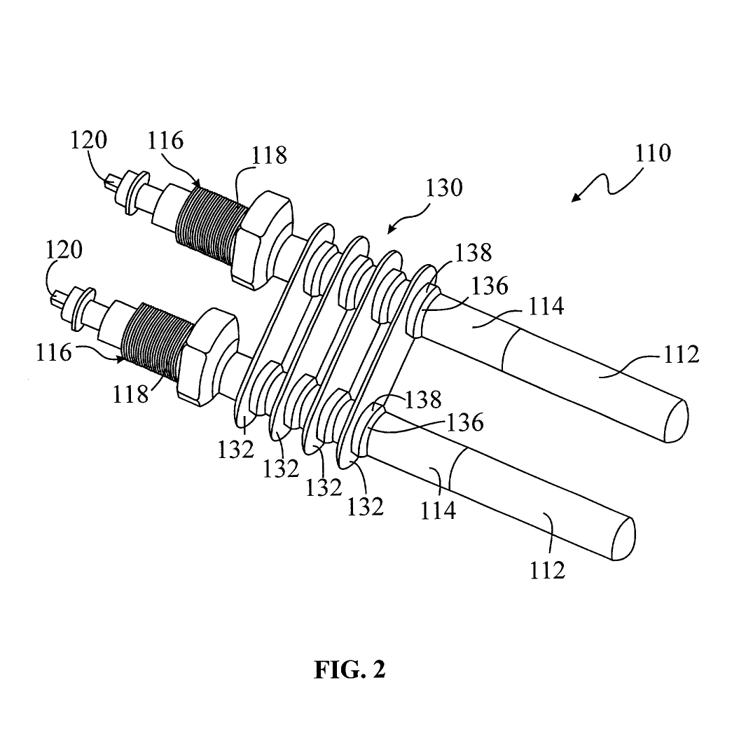

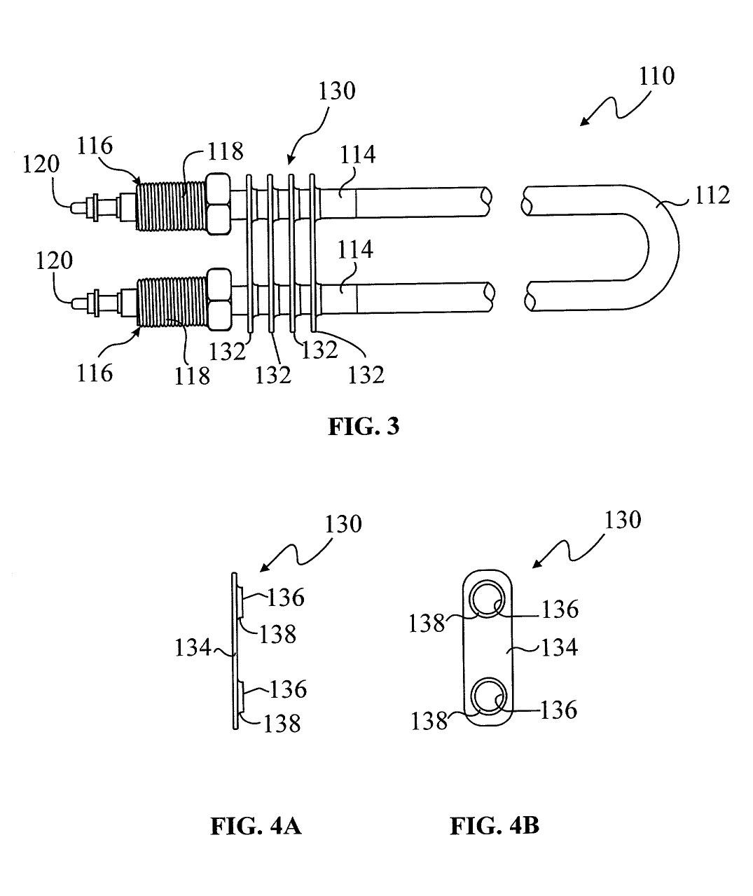

Illustrative embodiments will now be described with reference to the accompanying figures. Turning to the drawings, FIGS. 2 and 3 show a heater 110 according to the present invention. In one embodiment, the heater 110 has a heater element portion 112, cold pin portions 114, connectors 116, and at least one heat dissipation device 130.

The connectors 116 have a base 118 and an electrical terminal 120. The bases 118 of the connectors 116 are used for mechanically attaching the heater to a wiring enclosure or other housing (not shown). The terminals 120 of the connectors 116 are used for electrically connecting the heater 110 to a power source and controller.

The terminals 120 of the connector 116 are electrically connected to the heater element portion 112. In one embodiment, the heater element portion 112 is a tubular heater element that has one turn so that the terminals 120 are located in close proximity to each other. The present invention, however, is not limited to this specific design of a heater element portion and is applicable to other shapes and sizes. When power is provided to the heater 110 via the electrical terminals 120, the heater element portion 112 will generate heat. The heater 110 has two cold pin portions 114 that extend between the heater element portion 112 and the connectors 116 but do not actively generate heat when power is applied to the heater 110.

A heat dissipation device 130 is preferably attached to each of the cold pin portions 114 of the heater 110. In one embodiment, the heat dissipation device 130 has at least one strip 132 that extends between the two cold pin portions 114. As shown in FIGS. 4A and 4B, each strip 132 has a body portion 134 and holes or slots 136. The holes or slots 136 are used to attach the strip 132 to the cold pin portions 114. The attachment may be made by crimping, staking, welding or brazing the strip 132 to the cold pin portions 114. What is important is that the attachment provide a good contact surface between the cold pin portions 114 and the strip 132. To provide a better conducting surface, each hole or slot 136 may have a ridge 138. The body portion 134 is used to conduct and convect heat that has transferred to the cold pin portions 114 from the heater element portion 112. The heat dissipation device 230 is made of a heat conducting material. Suitable materials may include brass, aluminum, steel or Monel®.

The use of the heat dissipation device 130 lowers the temperatures of the connectors 116 and any attached wiring, wiring enclosure or controller. This is accomplished by dissipating conducted heat through convection to the surrounding air before the conducted heat reaches the connectors 116. Peripheral temperatures are reduced by the use of the heat dissipation device 130 to the point where standard wiring may be used to connect power to the heater 110. The number and size of the strips 132 for the heat dissipation device 130 is implementation specific. Increasing the number of strips or size will enhance the heat dissipating abilities of the heat dissipation device 130.

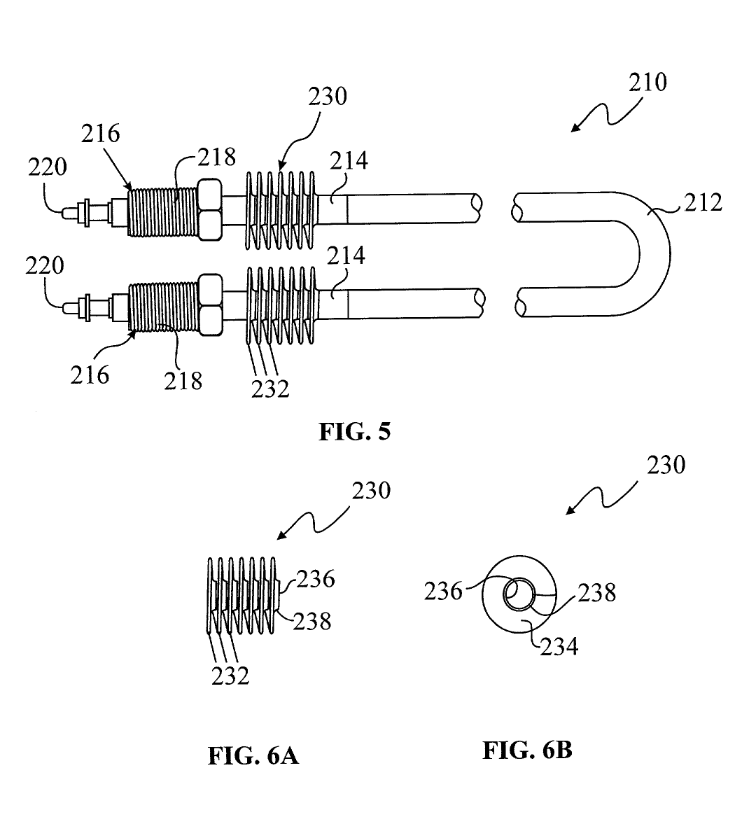

FIG. 5 shows another embodiment of a heater 210 according to the present invention. In this embodiment, the heater 210 has a heater element portion 212, cold pin portions 214, connectors 216, and at least one heat dissipation device 230.

The connectors 216 have a base 218 and an electrical terminal 220. The bases 218 of the connectors 216 are used for mechanically attaching the heater to a wiring enclosure or other housing (not shown). The terminals 220 of the connectors 216 are used for electrically connecting the heater 210 to a power source and controller.

Similar to the previous embodiment, the terminals 220 are electrically connected to the heater element portion 212. The heater element portion 212 may be a tubular heater element that has at least one turn so that the terminals 220 are located in close proximity to each other. When power is provided to the heater 210 via the electrical terminals 220, the heater element portion 212 will generate heat. The heater 210 has two cold pin portions 214 that extend between the heater element portion 212 and the connectors 216 but do not actively generate heat when power is applied to the heater 210.

A heat dissipation device 230 is preferably attached to each of the cold pin portions 214 of the heater 210. In this embodiment, however, the heat dissipation device 230 has a plurality of discs 232 that surround each cold pin portion 214. As shown in FIGS. 6A and 6B, each disc 232 has a body portion 234 and holes or slots 236. The holes or slots 236 are used to attach the disc 232 to the cold pin portions 214. The attachment may be made by crimping, staking, welding or brazing the disc 232 to the cold pin portions 214. As with the previous embodiment, what is important is that the attachment provides a good contact surface between the cold pin portions 214 and the discs 232. To provide a better conducting surface, each hole or slot 236 may have a ridge 238. The body portion 234 is used to conduct and convect heat that has transferred to the cold pin portions 214 from the heater element portion 212.

The heat dissipation devices 230 shown in FIGS. 6A and 6B are made of a heat conducting material. Suitable materials may include brass, aluminum, steel or Monel®. The heat dissipation device 230 may comprise of individual discs 232 or formed from a single strip of metallic material wrapped around the cold pin portions 214.

The use of the heat dissipation devices 230 lowers the temperatures of the connectors 216 and any attached wiring, wiring enclosure or controller. This is accomplished by dissipating conducted heat through convection to the surrounding air before the conducted heat reaches the connectors 216. Peripheral temperatures are reduced by the use of the heat dissipation device 230 to the point where standard wiring may be used to connect power to the heater 210. The number and size of the discs 232 for the heat dissipation device 230 is implementation specific. Increasing the number of discs or size will enhance the heat dissipating abilities of the heat dissipation device 230.

FIG. 7 shows another embodiment of a heater 310 according to the present invention. In this embodiment, the heater 310 has a heater element portion 312, cold pin portions 314, connectors 316, and at least one heat dissipation device 330.

The connectors 316 have a base 318 and an electrical terminal 320. The bases 318 of the connectors 316 are used for mechanically attaching the heater to a wiring enclosure or other housing (not shown). The terminals 320 of the connectors 316 are used for electrically connecting the heater 310 to a power source and controller.

Similar to the previous embodiments, the terminals 320 are electrically connected to the heater element portion 312. The heater element portion 312 may be a tubular heater element that has at least one turn so that the terminals 320 are located in close proximity to each other. When power is provided to the heater 310 via the electrical terminals 320, the heater element portion 312 will generate heat. The heater 310 has two cold pin portions 314 that extend between the heater element portion 312 and the connectors 316 but do not actively generate heat when power is applied to the heater 310.

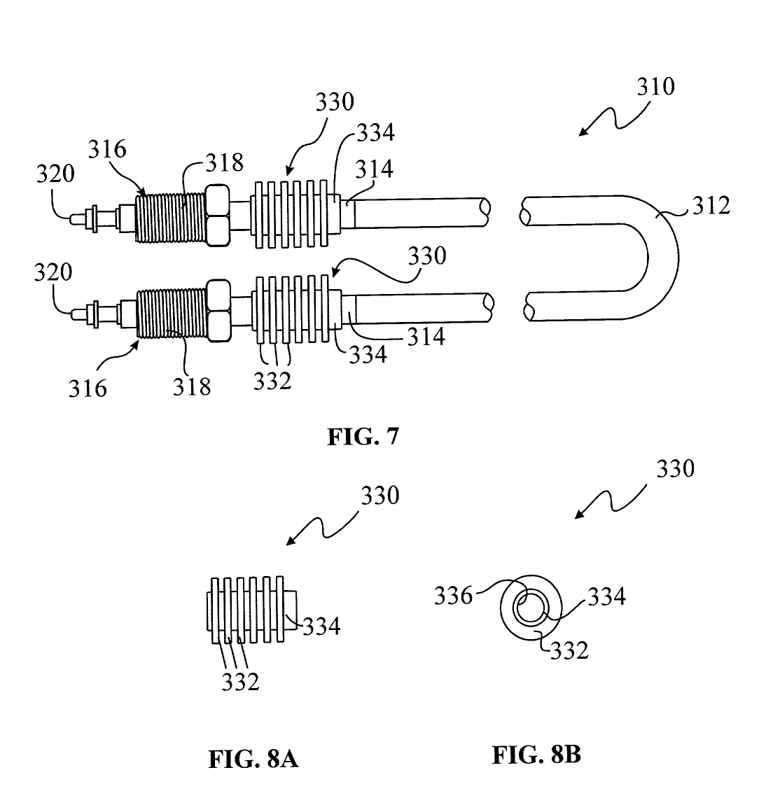

A heat dissipation device 330 is preferably attached to the cold pin portions 314 of the heater 310. In this embodiment, however, the heat dissipation device 330 has a tubular body portion 334 and a plurality of fins 332. The plurality of fins 332 are attached to the body portion 334 of the heat dissipation device 330. As shown in FIGS. 8A and 8B, the body portion 334 has a hole or slot 336. The hole or slot 336 is used to slide over the cold pin portion 314 of the heater 310. The heat dissipation device 330 is then attached to the cold pin portions 314 by crimping, staking, welding or brazing the body portion 334 of the heat dissipation device 330 to the cold pin portions 314. As with the previous embodiments, what is important is that the attachment provides a good contact surface between the cold pin portions 314 and the heat dissipation device 330. The fins 332 are used to conduct and convect heat that has transferred to the cold pin portions 314 from the heater element portion 312.

The heat dissipation devices 330 shown in FIGS. 8A and 8B are made of a heat conducting material. Suitable materials may include brass, aluminum, steel or Monel®. The heat dissipation device 330 may formed from a single piece of metallic material. Alternatively, the heat dissipation device 330 may be formed from separate components. For example, the body portion 334 may be a tube and individual fins 332 would be welded or otherwise attached to the body portion 334.

Like the previous embodiments, the use of the heat dissipation devices 330 lowers the temperatures of the connectors 316 and any attached wiring, wiring enclosure or controller. This is accomplished by dissipating conducted heat through convection to the surrounding air before the conducted heat reaches the connectors 316. Peripheral temperatures are reduced by the use of the heat dissipation device 330 to the point where standard wiring may be used to connect power to the heater 310. The number and size of the fins 332 for the heat dissipation device 330 is implementation specific. Increasing the number of fins or size will enhance the heat dissipating abilities of the heat dissipation device 330.

What has been described are heat dissipation devices that may be used with heaters to dissipate heat and protect sensitive wiring and components attached to the electrical connector of the heater. The heat dissipation devices described herein reduce the temperature of the electrical connector and attached wiring and components. This reduces the need for more expensive temperature resistant wiring and components. It also reduces the need for use of secondary cooling methods such as fans or refrigeration.

While the invention has been described with reference to the preferred embodiments, obvious modifications and alterations are possible by those skilled in the related art. Therefore, it is intended that the invention include all such modifications and alterations to the full extent that they come within the scope of the following claims or the equivalents thereof.

What is claimed is:

1. A heat dissipation device for a heater, the heater having a heater element portion, cold pin portions and connectors, the heat dissipation device comprising a body portion, the body portion of the heat dissipation device attached to at least one of the cold pin portions to dissipate heat conducted to the cold pin portion from the heater element portion.

2. The heat dissipation device of claim 1, wherein the body portion is in the shape of a strip, the strip extending between the cold pin portions.

3. The heat dissipation device of claim 1, wherein the body portion is in the shape of a disc.

4. The heat dissipation device of claim 1, wherein heat dissipation device further has a plurality of fins, the plurality of fins extending from the body portion.

5. A heater comprising:
a heater element portion having a first and second end;
a first cold pin portion connected to the first end of the heater element portion;
a second cold pin portion connected to the second end of the heater element portion;
a first connector attached to the first cold pin portion;
a second connector attached to the second cold pin portion; and
at least one heat dissipation device attached to the first cold pin portion and the second cold pin portion.

6. The heater of claim 5, wherein the at least one heat dissipation device is a metallic strip that extends between the first cold pin portion and the second cold pin portion.

7. The heater of claim 5, wherein the at least one heat dissipation device is made of brass.

8. The heater of claim 5, wherein the at least one heat dissipation device is made of steel.

9. The heater of claim 5, wherein the at least one heat dissipation device is attached to the first cold pin portion and the second cold pin portion by crimping.

10. A heater comprising:
a heater element portion having a first and second end;
a first cold pin portion connected to the first end of the heater element portion;
a second cold pin portion connected to the second end of the heater element portion;
a first connector attached to the first cold pin portion;
a second connector attached to the second cold pin portion;
a first heat dissipation device attached to the first cold pin portion; and
a second heat dissipation device attached to the second cold pin portion.

11. The heater of claim 10, wherein at least one of the first or second heat dissipation devices has a body portion in the shape of a disc.

12. The heater of claim 11, wherein the at least one of the first or second heat dissipation devices is made of a metallic material.

13. The heater of claim 10, wherein at least one of the first or second heat dissipation devices has a body portion and a plurality of fins.

14. The heater of claim 13, wherein the at least one of the first or second heat dissipation devices is made of a metallic material.

15. A heater comprising:
a heater element portion having a first and second end;
a first cold pin portion connected to the first end of the heater element portion;
a second cold pin portion connected to the second end of the heater element portion;
a first connector attached to the first cold pin portion;
a second connector attached to the second cold pin portion; and
a means attached to the first and second cold pin portions for dissipating the heat from the heater element portion.

16. The heater of claim 15, wherein the dissipation means includes a metallic strip that extends between the first cold pin portion and the second cold pin portion.

17. The heater of claim 16, wherein the metallic strip has at least one hole and a ridge protruding from an outer edge of the hole for attachment to the first and second cold pin portions.

18. The heater of claim 15, wherein the dissipation means includes a series of circular discs.

19. The heater of claim 15, wherein dissipation means includes a body portion and a plurality of fins, the plurality of fins extending from the body portion, the body portion attached to the first and second cold pin portions.

20. The heater of claim 15, wherein dissipation means is made of a metallic material.
